(19) United States
(12) Patent Application Publication
(10) Pub. No.: US 2026/0151954 A1
(43) Pub. Date: Jun. 4, 2026

(54) FLOORING PLANK BENDING DEVICE

(71) Applicant: Adonis Padilla, Orlando, FL (US)

(72) Inventor: Adonis Padilla, Orlando, FL (US)

(21) Appl. No.: 19/387,021

(22) Filed: Nov. 12, 2025

Related U.S. Application Data
(60) Provisional application No. 63/719,404, filed on Nov. 12, 2024.

(51) Int. Cl. B29C 53/04; B29C 53/80; B29K 55/00; B29L 7/00

(52) U.S. Cl. CPC B29C 53/04; B29C 53/80; B29K 2055/00; B29L 2007/007

(57) ABSTRACT

A vinyl floor plank bending device is provided comprising a receiver forming a gap configured to partially receive a floor plank, a sliding rail coupled to the receiver and configured to selectively adjust a width of the gap corresponding to a thickness of the floor plank, a folding member pivotally connected to the receiver by at least one hinge, and a handle coupled to the folding member and configured to apply pressure to bend the floor plank at a desired angle. The device may include an interchangeable mold removably attached to the receiver, the mold defining a bending profile for the floor plank. The vinyl floor plank bending device may be constructed of lightweight materials such as aluminum and may be configured for single-hand operation to form square or round stair-nose profiles with adjustable gap dimensions for various plank thicknesses.

### CROSS-REFERENCE TO RELATED APPLICATIONS

The present application claims priority to U.S. Provisional Patent Application 63/719,404 filed on Nov. 12, 2024, entitled “FLOOR PLANK BENDING DEVICE” the entire disclosure of which is incorporated by reference herein.

### TECHNICAL FIELD

The embodiments disclosed herein generally relate to flooring installation equipment, and more specifically to a flooring plank bending device configured to form precise bends in vinyl plank flooring for stair nose applications and other architectural transitions.

### BACKGROUND

The installation of flooring materials has evolved significantly over the past several decades, progressing from manual carpentry techniques to sophisticated mechanical and semi-automated systems. Historically, installers relied on hand tools, adhesives, and mechanical fasteners to secure materials such as wood, linoleum, or ceramic tile. Each type of flooring required specialized equipment and skills to achieve a durable and aesthetically pleasing finish. As architectural design trends increasingly favored clean transitions between floor surfaces and staircases, the need for precise edge treatments, including stair noses and transition moldings, became a critical element of both form and function in flooring installations.

With the introduction of vinyl plank flooring in the latter half of the twentieth century, installers were presented with a resilient and versatile material capable of mimicking the appearance of wood or stone while providing durability and water resistance. However, the very flexibility that made vinyl attractive also introduced new challenges in shaping and installation. Vinyl planks often required heat to be applied prior to bending or contouring them to fit around stair edges or transitions. Traditional tools and techniques used for hardwood or laminate were not optimized for the pliability of vinyl materials, leading to inconsistent results, material cracking, and uneven bends.

As the popularity of luxury vinyl plank flooring expanded, professional installers sought improved methods for creating stair nose profiles and edge transitions. Early bending machines and manual jigs were developed to address these needs, yet many of these devices were cumbersome, requiring multiple operators, external heating equipment, and repeated manual adjustments. The lack of adjustability for different plank thicknesses often resulted in a poor fit or damage to the material. Moreover, existing tools were generally limited to producing a single bending configuration, such as a basic 90-degree angle, restricting the installer's ability to produce both square and round stair noses with precision.

Despite advancements in thermal forming and bending equipment, the flooring industry continued to experience inefficiencies in the production of custom stair noses. Installers frequently resorted to ad hoc methods such as manually pressing heated planks against improvised molds or work surfaces. These techniques, while functional, were labor-intensive, inconsistent, and presented safety concerns due to the use of open heat sources and inadequate mechanical support. The absence of a compact, portable, and adjustable bending machine capable of forming multiple stair nose geometries remained an unsolved problem within the field.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to a vinyl floor plank bending device configured to allow a single installer to efficiently bend vinyl flooring planks into precise shapes for stair noses and transitions. The vinyl floor plank bending device includes a receiver forming a gap configured to partially receive a floor plank. The device further includes a sliding rail coupled to the receiver and configured to selectively adjust a width of the gap, wherein the width corresponds to a thickness of the floor plank. A folding member is pivotally connected to the receiver by at least one hinge, and a handle is coupled to the folding member and configured to apply pressure to bend the floor plank at a predetermined angle. The vinyl floor plank bending device provides a lightweight, portable, and adjustable structure that reduces the time and complexity associated with bending vinyl flooring materials.

In one embodiment, the receiver forms a gap defined by a first member and a second member that cooperate to partially receive and retain a floor plank. The first member and second member are aligned along the sliding rail such that the distance between them may be adjusted to correspond to the thickness of the floor plank being bent. The receiver ensures that the floor plank is securely positioned during operation to maintain a consistent bend along the plank's surface. The gap provides lateral stability while allowing a portion of the floor plank to protrude for bending. This configuration enables repeatable and uniform results across varying flooring materials and sizes.

The sliding rail is configured to enable selective adjustment of the width of the gap between the first member and the second member. The sliding rail allows precise control of the spacing between the receiver components, ensuring compatibility with flooring planks of different thicknesses. In certain embodiments, the sliding rail is configured to adjust the gap width between approximately four millimeters and ten millimeters. The sliding rail may include linear bearings or frictional guides to facilitate smooth movement during adjustment. This adjustable configuration enhances the versatility of the vinyl floor plank bending device.

The folding member is pivotally connected to the receiver via at least one hinge, enabling rotational movement of the folding member relative to the receiver. The hinge serves as the pivot axis that defines the bending motion applied to the floor plank. When the handle applies downward pressure, the folding member rotates about the hinge, pressing against the floor plank to form a bend at a predetermined angle. The hinge configuration provides mechanical leverage to reduce the effort required to form a bend. The use of the hinge in combination with the folding member allows consistent and controlled bending of the floor plank.

The handle is coupled to the folding member and configured to apply pressure to bend the floor plank at a desired angle. The handle serves as the user interface that transmits manual force to the folding member through the hinge connection. The length and shape of the handle are configured to allow single-hand operation, enabling efficient use by one installer. In certain embodiments, the handle includes an ergonomic grip to enhance control and reduce operator fatigue. The handle provides sufficient mechanical advantage to perform a bending operation with minimal force.

In one embodiment, the folding member is configured to bend the floor plank at approximately ninety degrees. This configuration is suitable for creating stair nose profiles or vertical edge transitions where a right-angle bend is required. The ninety-degree bend can be achieved consistently across multiple flooring planks without deformation or surface damage. The use of the hinge and handle ensures that the bend line remains uniform along the plank's length. This aspect of the vinyl floor plank bending device provides a reliable solution for installers forming square stair noses.

In another embodiment, the folding member is configured to bend the floor plank into a U-shaped configuration. The U-shaped bend is particularly useful for forming stair noses that wrap around the edge of a step or for other curved transition applications. The folding member and hinge cooperate to allow the floor plank to be bent beyond ninety degrees while maintaining material integrity. The radius of curvature for the U-shaped configuration can be modified by using an interchangeable mold. This provides flexibility for installers to create both angular and rounded stair nose designs.

The vinyl floor plank bending device further comprises an interchangeable mold removably attached to the receiver, the mold defining a bending profile for the floor plank. The interchangeable mold may be secured to the receiver through fasteners, slide-fit channels, or magnetic coupling. The mold's shape determines the final contour of the bent floor plank, ensuring precision and repeatability. The use of removable molds allows the user to quickly switch between different bending profiles without changing the primary components of the device. This modular configuration enhances the functionality of the vinyl floor plank bending device.

The interchangeable mold may include a square mold and a round mold, each defining a distinct bending profile. The square mold enables the formation of sharp angular bends such as stair noses with flat vertical and horizontal surfaces. The round mold enables the formation of smooth, continuous curves for rounded stair noses or decorative applications. The ability to alternate between the square mold and the round mold provides multi-functional capability within a single device. The removable design of the molds ensures that users can adapt the device to diverse flooring design requirements. This dual-mold configuration reduces the need for multiple specialized tools.

The sliding rail may include a locking mechanism configured to secure the receiver at a fixed position during bending. The locking mechanism prevents movement of the sliding rail once the desired gap width is established, ensuring dimensional stability throughout the bending process. The locking mechanism may comprise threaded fasteners, clamps, or detent pins that engage with the sliding rail track. By maintaining the receiver in a fixed position, the locking mechanism prevents material slippage and ensures uniform bends. This structural feature contributes to consistent performance and enhanced safety during operation.

In another embodiment, the handle is configured for single-hand operation to enhance user efficiency and control. The handle geometry allows the installer to exert bending pressure while simultaneously positioning or supporting the floor plank. Single-hand operation reduces operator fatigue and simplifies the installation process. The mechanical advantage provided by the hinge and handle allows the installer to perform the bending operation without requiring assistance. This single-user configuration improves field productivity and reduces labor costs associated with flooring installation.

The receiver and the folding member are preferably constructed of aluminum to provide a lightweight and portable structure. Aluminum offers high strength-to-weight ratio, corrosion resistance, and ease of fabrication, making it ideal for portable construction tools. The aluminum composition allows the vinyl floor plank bending device to be easily transported between job sites. The low weight enhances maneuverability while maintaining durability for repetitive use. The choice of aluminum ensures that the device is both robust and convenient for professional installers.

The receiver may include a clamping mechanism configured to retain the floor plank within the gap during bending. The clamping mechanism ensures that the floor plank remains stationary relative to the receiver, maintaining alignment during the application of bending pressure. The clamping mechanism may include spring-loaded elements or screw-adjustable jaws integrated into the receiver. This configuration minimizes slippage and ensures that the bend occurs precisely along the intended line. The clamping mechanism thus contributes to both accuracy and safety of the bending process.

The folding member may comprise multiple hinges configured to distribute bending pressure evenly along the width of the floor plank. Multiple hinges provide a distributed load path that minimizes localized stress and prevents cracking or surface deformation. Each hinge contributes to a uniform bending motion that produces a consistent bend radius across the entire plank. This design allows for larger planks or thicker materials to be bent effectively. The multiple-hinge arrangement provides structural reinforcement for heavy-duty or extended-use applications.

The handle may include an ergonomic grip configured to enhance user control and comfort during operation. The ergonomic grip may comprise a molded polymer or rubber surface contoured to fit the natural curvature of the hand. This design reduces hand fatigue during prolonged use and improves handling precision. The ergonomic configuration allows the installer to exert more controlled pressure throughout the bending operation. The inclusion of an ergonomic grip improves overall device usability and operator satisfaction.

In one embodiment, the receiver is mounted on a base configured to be secured to a workbench or table. The base provides additional stability to the vinyl floor plank bending device during operation, reducing vibration and movement. The base may include mounting holes, clamps, or non-slip feet to attach securely to the work surface. A stable base ensures consistent bending performance across multiple operations. This configuration enhances safety and accuracy during the bending process.

The receiver may include measurement indicators positioned adjacent to the gap to assist with floor plank alignment. The measurement indicators allow users to visually position the floor plank at precise distances relative to the bend line. The indicators may be engraved, printed, or embedded on the receiver surface for durability. These visual markers reduce setup time and improve repeatability when forming multiple identical bends. The inclusion of measurement indicators adds precision and user convenience to the vinyl floor plank bending device.

The folding member may include a replaceable contact pad configured to prevent damage to a surface of the floor plank during bending. The contact pad may be composed of a soft yet durable material such as silicone, rubber, or urethane. The pad distributes the applied pressure evenly across the plank's surface, minimizing the risk of surface marring or delamination. When worn, the contact pad can be easily replaced to maintain consistent performance. This feature preserves the quality and finish of the vinyl flooring material.

The receiver defines a gap depth of approximately one inch to ensure sufficient engagement between the floor plank and the receiver during bending. The defined depth allows the floor plank to be securely retained while still permitting the desired degree of movement for bending. The one-inch gap depth provides optimal leverage for forming both right-angle and U-shaped bends. This dimensional specification ensures compatibility with standard vinyl plank dimensions. The controlled gap depth contributes to the accuracy and repeatability of each bend.

In another embodiment, the vinyl floor plank bending device may be part of a system for bending vinyl floor planks comprising a receiver, a sliding rail mechanism, a folding member, one or more hinges, a handle, and an interchangeable mold. The system allows for the controlled shaping of vinyl floor planks into various profiles, including square and round stair noses. The coordinated operation of the receiver, sliding rail, folding member, and mold provides the mechanical precision necessary for consistent results. This system simplifies the installation process while maintaining flexibility for different flooring configurations. The invention thus represents a significant improvement over conventional manual or multi-operator bending methods.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the vinyl floor plank bending device and a floor plank bent in a U-shape, according to some embodiments; and

FIG. 2 illustrates a perspective view of the vinyl floor plank bending device, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a A vinyl floor plank bending device may include several mechanical components that cooperate to bend a vinyl floor plank at one or more angles suitable for forming stair noses or similar structures. Each component may perform a distinct mechanical function and may be configured to operate in conjunction with the others to produce controlled, repeatable bending motions. The device may include a receiver forming a gap configured to partially receive a floor plank, a sliding rail coupled to the receiver and configured to selectively adjust a width of the gap, a folding member pivotally connected to the receiver by at least one hinge, and a handle coupled to the folding member and configured to apply pressure to bend the floor plank at a desired angle. Each of these elements may be fabricated using materials capable of withstanding repeated mechanical stresses during bending operations.

The receiver forming the gap may include a first member and a second member that cooperate to define a space into which the floor plank may be inserted. The receiver may support the floor plank along its length while leaving a portion of the plank exposed above the gap for bending. The first member and second member may be oriented in parallel or near-parallel alignment to maintain uniform clamping along the width of the plank. The receiver may include planar or contoured surfaces to distribute load evenly across the inserted section of the plank. By securing the floor plank within the receiver gap, consistent positioning may be achieved for repeated bending operations.

The receiver may define a gap that extends longitudinally along a portion of the device to accommodate planks of varying widths. The depth of the gap may be approximately one inch, although the exact depth may vary depending on the desired bend geometry. The width of the gap may correspond to the thickness of the floor plank and may be selectively adjustable through use of a sliding rail. The receiver may be constructed of rigid materials such as aluminum, steel, or other alloys capable of maintaining structural integrity during compressive loading. Surfaces of the receiver may include protective coatings or pads to prevent marking or scratching of the vinyl plank.

The sliding rail coupled to the receiver may be configured to selectively adjust the width of the gap between the first member and the second member. The sliding rail may extend along the receiver's length and may include one or more linear tracks or dovetail grooves that guide the movement of the adjustable member. Adjustment may be performed by sliding one of the receiver members laterally along the rail until the desired gap width is achieved. The rail may include scale markings or measurement indicators to assist the user in aligning the receiver for specific plank thicknesses. Once positioned, the rail may be locked in place to maintain the selected spacing during bending.

A locking mechanism may be integrated into the sliding rail to secure the receiver at a fixed position. The locking mechanism may include threaded fasteners, compression levers, or spring-loaded detents that engage the rail body to prevent unintentional movement. When actuated, the locking mechanism may clamp the movable receiver member against the fixed member to maintain the selected gap width. The locking function may ensure that the floor plank remains stable while bending forces are applied. The locking mechanism may be manually released to adjust the receiver for a different plank thickness.

The folding member may be pivotally connected to the receiver by at least one hinge and may be configured to apply pressure to the floor plank. The folding member may be formed as an elongated plate or bar that extends parallel to the receiver. During operation, the folding member may rotate around the hinge axis to press against the portion of the plank extending above the receiver. The rotational motion of the folding member may be guided and limited by the hinge geometry to control the final bending angle. The folding member may include a replaceable contact pad that contacts the surface of the plank to distribute pressure uniformly.

The hinge connecting the folding member to the receiver may serve as the rotational pivot point for bending operations. The hinge may comprise one or more cylindrical pins, bearings, or knuckle joints that enable smooth rotational motion. In some embodiments, multiple hinges may be spaced along the width of the device to distribute mechanical load evenly. The hinge axis may be aligned with the bend line of the plank so that pressure from the folding member produces a controlled curvature. The hinge construction may permit disassembly or maintenance, allowing lubrication or replacement of components after extended use.

The handle may be coupled to the folding member and configured to apply pressure sufficient to bend the floor plank. The handle may extend upward or outward from the folding member to provide mechanical leverage to the user. By actuating the handle, the user may exert a downward or forward force that causes the folding member to rotate around the hinge axis. The handle may be sized and shaped for single-hand operation and may include a contoured grip to improve comfort and control. The geometry of the handle may be selected to provide adequate moment arm length for efficient force transfer with minimal physical effort.

The folding member may be configured to bend the floor plank at approximately ninety degrees, forming an angle suitable for square stair noses. When the handle is actuated, the folding member may rotate downward until the plank is pressed firmly against the receiver or a mold surface positioned beneath it. The angle of rotation may be mechanically limited by a stop feature integrated into the hinge assembly or the folding member structure. The device may enable consistent 90-degree bends across repeated operations by maintaining uniform mechanical geometry and pressure application. The resulting bent section may be allowed to cool and retain the angular shape.

In another configuration, the folding member may bend the floor plank into a U-shaped configuration suitable for rounded stair noses. This may be achieved by extending the hinge rotation beyond ninety degrees or by positioning a mold within the receiver to define a curved bending surface. The U-shaped bend may result from the combined action of the folding member's pressure and the contour of the mold. The radius of curvature may be controlled by the shape of the mold and the position of the receiver gap. This configuration may allow an installer to produce multiple stair nose geometries using the same mechanical assembly.

An interchangeable mold may be removably attached to the receiver, the mold defining a bending profile for the floor plank. The mold may be inserted into a cavity or slot within the receiver and may be retained by screws, clamps, or slide-in guides. The mold may have a square shape for producing angular bends or a round shape for forming smooth curved profiles. The interchangeable configuration may allow the operator to replace one mold with another without disassembling the primary structure. Each mold may be machined or cast to specific dimensional tolerances to ensure consistent bending performance.

The interchangeable mold may cooperate with the receiver and folding member to form the desired profile in the vinyl plank. The mold surface may contact the underside of the plank during bending, providing support to prevent material deformation. The mold geometry may determine the bend radius and the final shape of the plank's nose section. A square mold may include flat orthogonal surfaces, while a round mold may include a concave curvature. The molds may be fabricated from heat-resistant and wear-resistant materials to withstand repeated contact with heated vinyl planks.

The receiver and folding member may be constructed of aluminum or another lightweight metal to enhance portability and ease of use. Aluminum components may be extruded, milled, or cast into desired geometries and may be anodized for surface protection. The use of lightweight materials may reduce operator fatigue and facilitate transport between work areas. Aluminum also provides sufficient structural rigidity to withstand repeated mechanical stresses from bending operations. The combination of low weight and durability may allow the device to be deployed in field and workshop environments alike.

The receiver may include a clamping mechanism configured to retain the floor plank within the gap during bending. The clamping mechanism may include one or more adjustable jaws, springs, or cam levers that press against the plank surfaces. When engaged, the clamp may secure the plank against movement, ensuring that bending occurs precisely along the intended line. The clamping force may be manually adjustable to accommodate different materials and hardness levels. The inclusion of the clamping mechanism may improve repeatability and alignment accuracy during bending operations.

The receiver may include measurement indicators positioned adjacent to the gap to assist with alignment of the floor plank. The indicators may be etched, printed, or embedded along the receiver surface to indicate distances from the bending line. These markings may allow an operator to align planks consistently for successive bends of equal dimension. The measurement indicators may also be used to position the plank for partial bends or to create decorative edge features. Such markings may be calibrated to standard flooring dimensions for quick visual reference.

The folding member may include a replaceable contact pad configured to prevent damage to the surface of the floor plank during bending. The contact pad may be attached to the underside of the folding member using adhesive, fasteners, or a slot-retaining design. The pad material may be compliant enough to distribute pressure evenly while maintaining sufficient stiffness for controlled bending. Replacement of worn pads may be accomplished without disassembling the entire folding member. This component may extend the service life of the device while maintaining consistent quality of bent planks.

A base may support the receiver and may be configured to mount to a workbench or other surface for stability during use. The base may include one or more mounting holes or clamps to secure the device in place during bending. In some configurations, the base may include non-slip feet or a weighted platform to counteract applied forces. The base may help maintain consistent alignment between the receiver, folding member, and mold during repeated cycles. A stable base may allow for safer operation and improved accuracy when forming bends in vinyl flooring materials.

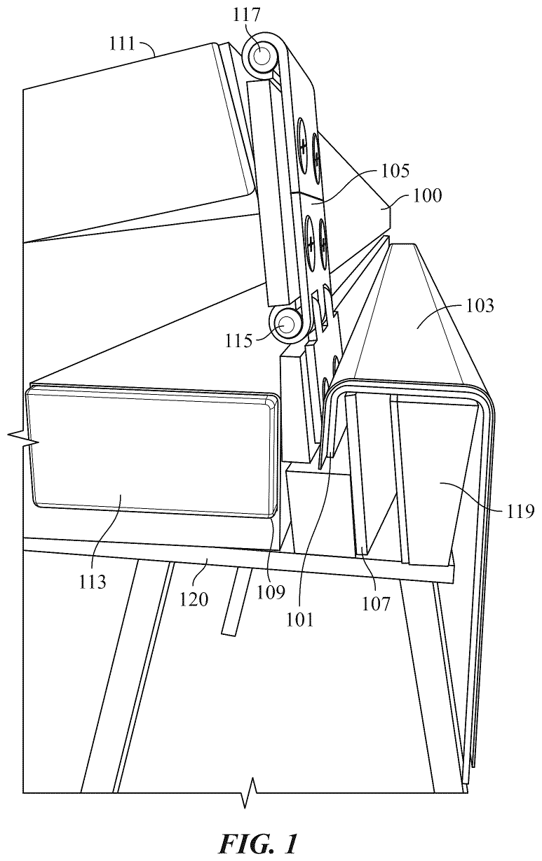

FIG. 1 illustrates a perspective view of a vinyl floor plank bending device 100 configured to bend a floor plank 103 at one or more angles. The device 100 may include a receiver 101 configured to partially receive the floor plank 103. The receiver 101 may define a gap formed between a folding member 105 and a second member 107. The folding member 105 may be positioned above the receiver 101 and may rotate downward to apply pressure against the floor plank 103. The second member 107 may support the floor plank 103 from below as it is bent around its edge.

The receiver 101 may be positioned along a sliding rail 109 that enables adjustment of the distance between the folding member 105 and the second member 107. The sliding rail 109 may extend longitudinally along the length of the receiver 101 and may include mechanical guides, tracks, or fasteners to permit precise positioning. By adjusting the position of the sliding rail 109, the width of the receiver 101 may be changed to correspond to the thickness of the floor plank 103. The sliding rail 109 may include a locking mechanism (not shown) that prevents the receiver 101 from shifting once the proper spacing has been selected. This adjustment capability allows the device 100 to accommodate vinyl floor planks having thicknesses ranging from approximately 4 mm to 10 mm.

The folding members 105 may be mounted to the receiver 101 through one or more hinges 115 and 117. The hinges 115 and 117 may define a rotational axis along which the folding members 105 move relative to the receiver 101. The folding members 105 may include planar faces that contact the upper surface of the floor plank 103 during bending. As the folding members 105 are rotated downward about the hinges 115 and 117, the upper surface of the floor plank 103 may be pressed against the contour defined by the second member 107 and a third member 119. This interaction may cause the floor plank 103 to bend along a defined bend line, forming a desired angular or curved shape suitable for a stair nose configuration.

The handles 111 and 113 may be attached to the folding members 105 and may extend outwardly to provide mechanical leverage during operation. The handles 111 and 113 may enable an operator to actuate the folding members 105 by applying a downward or forward force. Each handle may include a grip surface that enhances control and reduces slippage during manual operation. The positioning of the handles 111 and 113 on opposing sides of the folding members 105 may allow balanced application of pressure across the width of the floor plank 103. In some embodiments, the handles 111 and 113 may be operated simultaneously by a single hand to bend smaller planks, or separately to apply progressive force along a wider plank.

The hinges 115 and 117 may be mechanical pin-style joints that provide smooth, controlled rotation of the folding members 105. Each hinge may include a central pin extending through aligned openings in the folding members 105 and the receiver 101. The hinge construction may be selected to withstand repeated bending cycles and maintain alignment between the folding members 105 and the receiver 101. The axis defined by the hinges 115 and 117 may be located adjacent to the bend line of the floor plank 103, allowing the plank to fold evenly around the desired contour. The hinges 115 and 117 may also serve as alignment features that maintain parallel movement of both folding members 105 during operation.

The second member 107 may act as a support platform over which the floor plank 103 bends during use. The second member 107 may have a flat or radiused upper surface depending on the desired bend geometry. In configurations where the floor plank 103 is to be bent at approximately ninety degrees, the second member 107 may have a squared edge that defines a sharp bending line. When a rounded bend is required, the second member 107 may cooperate with the third member 119, which may serve as a removable or interchangeable mold element. The second member 107 may be rigidly connected to the receiver 101 to maintain stability during the application of downward force.

The third member 119 may be positioned adjacent to the second member 107 and may define a shaping surface that determines the curvature of the bend in the floor plank 103. The third member 119 may be removable to allow interchangeability between different mold shapes. In some embodiments, the third member 119 may include a concave radius to form a rounded stair nose, while in others it may include an angular surface to form a square stair nose. The third member 119 may be secured by fasteners or slide-fit channels that permit rapid replacement without disassembling the receiver 101. The cooperative engagement between the folding members 105, second member 107, and third member 119 may define the overall bending profile of the floor plank 103.

The floor plank 103 may be positioned within the receiver 101 such that a portion of its length extends outward from the device 100. The portion of the floor plank 103 within the receiver 101 may be held stationary, while the exposed portion is subjected to bending forces applied by the folding members 105. The operator may apply heat to the area of the floor plank 103 along the intended bend line prior to actuation. Once pliable, the floor plank 103 may be bent smoothly around the edge of the second member 107 or the contour of the third member 119. After bending, the plank may be allowed to cool, retaining its new shape.

The sliding rail 109 may be positioned below or integrated within the base of the receiver 101 to permit lateral movement for adjustment. The rail may be machined from aluminum and may include channels or grooves that mate with protruding elements of the receiver 101. Friction between these components may be reduced using bushings or linear bearings to ensure smooth motion. The ability to adjust the position of the receiver 101 using the sliding rail 109 may enable the user to accommodate various flooring materials without requiring separate bending devices. This configuration allows for quick setup and adjustment on site.

The handles 111 and 113, when actuated, may transmit mechanical force through the folding members 105 to the floor plank 103. The handles 111 and 113 may be connected by fasteners or welded joints that permit angular rotation about their mounting points. Each handle may extend upward from the folding member 105 at a predetermined angle that optimizes leverage during operation. When downward pressure is applied, the folding members 105 rotate about the hinges 115 and 117, causing the upper surface of the floor plank 103 to press into the mold defined by the third member 119. The user may then release the handles 111 and 113, allowing the folding members 105 to return to their neutral position for the next operation.

The receiver 101, second member 107, and third member 119 may be supported by a rigid frame that distributes the bending load across the device 100. The frame may be constructed of metal tubing or extruded channels and may include mounting provisions for attachment to an external surface. The device 100 may be positioned directly on a workbench or clamped to a support structure for additional stability. The assembly of these components may ensure that the bending operation occurs along a consistent plane without introducing torsional distortion to the floor plank 103. This structural arrangement enables the device 100 to perform multiple bending operations without adjustment or recalibration.

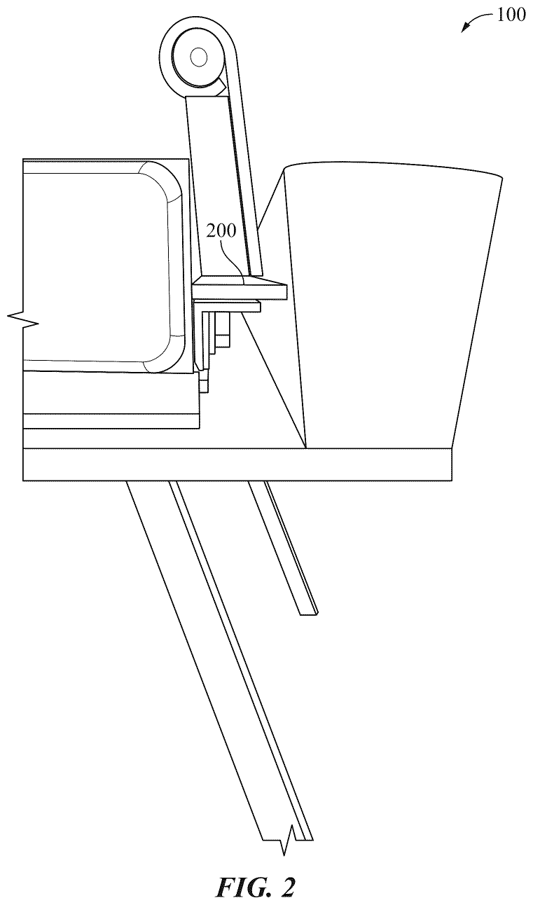

FIG. 2 illustrates the vinyl floor plank bending device 100 positioned on a table 200. The table 200 may provide a stable support platform that maintains the device 100 in an elevated and level orientation during use. In combination with FIG. 1, each of the elements are shown. The table 200 may include a flat upper surface that interfaces with the base of the receiver 101 and the sliding rail 109. The device 100 may be fastened or clamped to the table 200 to prevent movement when pressure is applied through the handles 111 and 113. The table 200 may also support longer floor planks 103 by providing a continuous planar surface to align the material before and after bending.

In the embodiment shown in FIG. 2, the floor plank 103 may be positioned such that its heated section is aligned with the folding members 105 and the edge of the second member 107. As the operator actuates the handle, the folding members 105 may rotate downward about the hinges 115 and 117, causing the plank to bend over the edge defined by the second member 107 and against the shaping surface of the third member 119. The table 200 may ensure that the base of the device 100 remains stationary during this operation, enabling consistent application of force. The overall configuration may allow a single operator to perform the bending process efficiently without assistance.

The integration of the table 200 with the device 100 may also provide ergonomic advantages during operation. The height of the table 200 may be selected to position the handles 111 and 113 within comfortable reach of the user. The table 200 may include adjustable legs or stabilizing crossbars to maintain balance during use. When not in use, the device 100 may be removed from the table 200 for transport or storage. The combination of the table 200 and device 100 may therefore provide a complete assembly suitable for both workshop and on-site flooring installation tasks.

In some embodiments, the device 100 may be configured to operate without a table 200 by incorporating a built-in base or stand. However, the use of the table 200 as shown in FIG. 2 may enhance precision by minimizing vibration and deflection during bending. The rigid surface of the table 200 may act as a reaction plane that absorbs and redistributes forces applied by the operator. The connection between the device 100 and the table 200 may be achieved through fasteners, clamps, or magnetic mounting systems depending on the application. This arrangement may allow the device 100 to be repositioned or transported easily between different workstations.

In operation, the device 100 may be used to bend a vinyl floor plank 103 to form either a square or round stair-nose profile. Before bending, the operator may position the device 100 on a flat and stable surface such as the table 200. The table 200 may be configured to provide a non-slip interface that prevents movement of the device 100 during use. The user may optionally secure the device 100 to the table 200 using clamps, bolts, or fasteners positioned along the device base. This configuration may ensure that the receiver 101, folding members 105, and second member 107 remain stationary relative to the operator's applied forces.

The operator may first select the appropriate gap width within the receiver 101 using the sliding rail 109. The width of the receiver 101 may be adjusted to correspond to the thickness of the floor plank 103 to ensure proper engagement during bending. To perform this adjustment, the operator may loosen a locking mechanism associated with the sliding rail 109, reposition one of the receiver components to the desired width, and re-engage the locking mechanism. This adjustable configuration may allow the device 100 to accommodate different flooring materials ranging from thin decorative planks to thicker composite planks. Once adjusted, the receiver 101 may hold the plank securely in position during bending.

The floor plank 103 may then be prepared for bending by applying heat along the intended bend line. Heating may be achieved using a heat gun, infrared heater, or other suitable heat source directed toward the surface of the floor plank 103. The heating step may be performed until the plank material becomes pliable, typically reaching a temperature at which the vinyl softens but does not deform uncontrollably. The localized heating may enable the material to yield under bending pressure while maintaining its structural integrity elsewhere. This step may be repeated for both single and double bend operations depending on the desired stair-nose profile.

After heating, the operator may insert the floor plank 103 into the receiver 101 so that a portion of the plank extends outward beyond the second member 107. The portion of the plank positioned within the receiver 101 may remain fixed, while the extended portion may be subjected to bending forces from the folding members 105. The operator may align the bend line of the floor plank 103 with the upper edge of the second member 107 or the shaping surface of the third member 119. This alignment may ensure that the bend occurs precisely along the desired contour. The user may confirm alignment visually using measurement indicators or physical markings on the receiver 101.

To initiate the bending operation, the operator may grasp one or both handles 111 and 113 and apply downward force. The handles 111 and 113 may transmit force through the folding members 105, causing them to rotate about the hinges 115 and 117. As the folding members 105 rotate, they may press the upper surface of the floor plank 103 downward against the second member 107 and third member 119. This action may cause the plank to bend along the heated section, taking the shape defined by the contour of the third member 119. The operator may continue to apply force until the desired bending angle or radius is achieved.

When forming a square stair nose, the folding members 105 may be rotated until the floor plank 103 forms an angle of approximately ninety degrees relative to the unbent section. The sharp edge of the second member 107 may define the corner of this bend, and the contact between the folding members 105 and the floor plank 103 may be uniform along the length of the device 100. The operator may hold the folding members 105 in this position until the floor plank 103 cools sufficiently to retain its shape. The result may be a consistent, crisp ninety-degree bend suitable for installation along a stair tread or riser. The uniform mechanical alignment provided by the hinges 115 and 117 may ensure that the bend line remains straight across the width of the plank.

To form a round stair nose, the operator may replace the third member 119 with an alternative mold having a curved shaping surface. The curved third member 119 may define a larger bending radius to produce a continuous, rounded edge on the floor plank 103. During operation, the folding members 105 may press the heated plank gradually against the curved mold, allowing the material to follow the arc of the surface without kinking or cracking. The resulting bend may have a radius proportional to the curvature of the third member 119. This configuration may allow installers to produce rounded stair noses or other smooth transition edges without requiring specialized factory equipment.

The bending process may be controlled by varying both the temperature applied during heating and the amount of force applied through the handles 111 and 113. Lower temperatures or lighter force may produce gentle curves, while higher temperatures or increased pressure may produce tighter bends. The operator may also adjust the duration of pressure application to fine-tune the bend angle. Once the desired shape is formed, the folding members 105 may be released, allowing the floor plank 103 to cool naturally in air or under light compression. The cooling period may allow the vinyl to harden and permanently retain its new profile.

The handles 111 and 113 may return to their initial positions automatically when pressure is released, either by gravity or through the inclusion of optional return springs. The operator may inspect the bent section of the floor plank 103 to confirm uniformity and angle accuracy. If necessary, minor adjustments may be made by reheating and reapplying pressure using the same process. Because the device 100 provides mechanical control over the bending angle, successive planks may be bent to identical dimensions without recalibration. This repeatability may allow the operator to produce multiple stair noses or transition pieces efficiently.

The user may also perform multiple bends along a single floor plank 103 to create complex profiles. For example, a U-shaped configuration may be achieved by performing two sequential bends using different positions of the folding members 105 relative to the receiver 101. The first bend may form one side of the U-shape, and the second bend may complete the opposing side. The sliding rail 109 may be readjusted between operations to modify the position of the receiver 101 for each bending cycle. The device 100 may thereby allow the production of compound profiles from a single plank, expanding its versatility in flooring installations.

During use, the device 100 may experience repetitive loads transmitted through the folding members 105, hinges 115 and 117, and receiver 101. These loads may be distributed across the structural frame and absorbed by the table 200 or mounting surface. The aluminum construction of the primary components may provide the stiffness required to maintain dimensional stability over multiple bending cycles. Surfaces of contact between the folding members 105, floor plank 103, and molds may be maintained clean to prevent debris from imprinting on the plank surface. The user may periodically apply lubricant to the hinges 115 and 117 and locking mechanisms to ensure smooth mechanical operation.

In certain configurations, the operator may attach auxiliary components to the device 100 for specific operational needs. For instance, protective shields may be installed to guard against contact with heated planks, or extension plates may be attached to accommodate longer floor planks 103. The device 100 may also be adapted with digital temperature sensors or bending angle gauges to monitor process parameters. These optional attachments may be secured to existing features of the receiver 101 or sliding rail 109 without modification of the base design. Such adaptability may support a range of professional and commercial flooring applications.

After the bending process, the floor plank 103 may be removed from the receiver 101 once it has cooled to ambient temperature. The bent section may exhibit a permanent shape that matches the contour of the mold and the geometry defined by the folding members 105 and second member 107. The finished stair nose or transition piece may then be trimmed, cut, or finished as required for installation. Because the bending process may be performed using manual force and heat, no adhesives or secondary bonding materials may be required. The use of the device 100 may therefore streamline the production of finished flooring components directly at the installation site.

The device 100 may also be used for testing and calibration of new vinyl materials or composite flooring products. By varying heat input, bend angle, and dwell time, the operator may determine the mechanical limits of different material formulations. The ability to perform controlled bends using a standardized mechanical setup may enable comparative testing between flooring types. This capability may be valuable for manufacturers or installers seeking to validate the flexibility, durability, or recovery behavior of new flooring materials. The device 100 may thus serve both as a functional bending tool and as a testing fixture for quality assurance.

In practice, the user may complete the bending sequence in a few minutes per plank, depending on material thickness and desired profile. The repeatable alignment provided by the receiver 101 and sliding rail 109 may allow a series of planks to be processed consecutively without adjustment. The mechanical leverage of the handles 111 and 113 may minimize physical strain while maintaining control over the applied force. The use of a table 200 or equivalent support may further enhance speed and accuracy. This operational process may be repeated as needed to produce uniform, professionally finished flooring components for installation.

The device 100 may be produced in a variety of configurations depending on material availability, manufacturing processes, or specific use environments. The receiver 101 may be formed as a single machined or cast piece, or as an assembly of discrete components joined by welding, fasteners, or adhesives. In some configurations, the receiver 101 may include modular sections that can be detached or replaced to accommodate varying lengths of floor plank 103. The modular receiver may enable transportation of the device 100 in compact form and rapid assembly at a job site. The geometry of the receiver 101 may be modified to include additional reinforcement ribs or gussets to maintain rigidity during bending operations.

The folding members 105 may be fabricated using precision-machined aluminum, extruded profiles, or high-strength polymer composites. The thickness of the folding members 105 may be selected to provide adequate stiffness while minimizing weight. The outer surface of the folding members 105 may include a protective coating or padding to reduce surface marking of the floor plank 103 during bending. In some configurations, the folding members 105 may include integrated heating elements to maintain uniform temperature across the contact surface, reducing the risk of uneven material softening. The folding members 105 may also include detachable inserts that define different bending surface geometries for specialized applications.

The hinges 115 and 117 may be implemented as removable pin hinges, piano hinges, or cylindrical journal bearings depending on desired performance characteristics. Each hinge may be mounted using through-bolts or threaded fasteners that permit replacement in the field without specialized tools. The hinge axes may be aligned with precision relative to the second member 107 to ensure consistent bending angles. In certain embodiments, the hinge components may be constructed of stainless steel or hardened steel to resist wear and corrosion. Lubrication fittings may be incorporated into each hinge to facilitate periodic maintenance and reduce friction during operation.

The handles 111 and 113 may be manufactured using tubular metal stock, molded polymer, or composite materials. Each handle may include a grip formed from thermoplastic elastomer or rubber to enhance comfort and control. The length of the handles 111 and 113 may be adjustable to modify leverage for different plank materials or operator preferences. For instance, an extendable handle may include a telescoping shaft locked by a friction collar. In other embodiments, the handles 111 and 113 may include quick-release connectors that allow them to be removed or repositioned for transport or storage. These variations may provide ergonomic flexibility for diverse installation environments.

The sliding rail 109 may be constructed from a linear motion system that includes bushings, bearings, or roller assemblies. The rail 109 may include engraved or printed measurement indicators spaced at defined intervals to assist in precise alignment of the receiver 101. The locking mechanism associated with the sliding rail 109 may employ threaded fasteners, lever clamps, or cam locks that secure the rail in place. The adjustable nature of the sliding rail 109 may permit calibration for different thicknesses of the floor plank 103 or for other bendable materials such as laminate, composite, or thermoplastic sheet. The rail system may be designed to maintain repeatable alignment through multiple cycles without drift or loosening.

The second member 107 may be fabricated with either a fixed or replaceable edge profile. In one configuration, the second member 107 may include a straight edge suitable for right-angle bends. In another configuration, the second member 107 may feature a replaceable insert that matches the contour of a selected third member 119. The material of the second member 107 may be hardened aluminum or steel to resist deformation from repeated pressure. The upper surface of the second member 107 may be polished, anodized, or coated with a low-friction finish to reduce sticking when the heated floor plank 103 contacts it during bending. The second member 107 may be attached to the receiver 101 using threaded fasteners that allow removal for maintenance or cleaning.

The third member 119 may serve as an interchangeable mold element configured to define the bend radius and shape of the floor plank 103. The third member 119 may be provided in multiple versions, each having a unique contour such as a square profile, semi-circular curve, or elliptical arc. The user may select the desired third member 119 based on the specific application and desired stair-nose geometry. The third member 119 may be manufactured from aluminum, steel, or heat-resistant polymer, depending on temperature requirements and expected loading. The removable configuration of the third member 119 may enable rapid transition between square and round bending operations without modifying other parts of the device 100.

In certain embodiments, the receiver 101 and associated components may be mounted on a rotatable frame that allows the user to change the orientation of the bending axis. The frame may include locking detents to secure the device 100 at various angles relative to the table 200. This rotational capability may allow bending in both horizontal and vertical orientations, depending on user preference and workpiece geometry. In other configurations, the device 100 may include leveling feet or adjustable supports to align the receiver 101 parallel to the table surface. Such configurations may improve control when bending longer or heavier flooring planks 103.

The table 200 may vary in design depending on workspace conditions. In workshop settings, the table 200 may be constructed of steel or heavy-duty wood and may be permanently mounted to a floor surface. In mobile or on-site environments, the table 200 may be lightweight and foldable for easy transport. The table 200 may include a non-slip mat or clamping system to hold the device 100 securely during operation. Electrical heating systems or power outlets may be integrated into the table 200 for convenience during plank heating. The table 200 may also include side extensions or roller supports to stabilize longer flooring sections during bending.

The receiver 101 may optionally incorporate a clamping mechanism configured to retain the floor plank 103 during operation. The clamping mechanism may include manual screw clamps, pneumatic cylinders, or spring-loaded jaws. Each clamp may apply a downward force to secure the floor plank 103 against movement while bending pressure is applied. The use of adjustable clamping pressure may enable the operator to adapt to varying material hardness or friction characteristics. The clamping mechanism may be integrated into the structure of the receiver 101 or mounted externally as an accessory attachment.

The device 100 may also be adapted for partial automation. In some embodiments, a powered actuator may replace manual operation of the handles 111 and 113. The actuator may include a pneumatic piston, hydraulic cylinder, or electric linear drive coupled to the folding members 105. Automated control may allow repeatable bending angles with reduced operator input. Sensors may be included to detect the position of the folding members 105, providing feedback for precision control. The automated configuration may be especially useful for production environments where large quantities of flooring planks 103 require uniform bending.

Alternative embodiments may use different materials for the primary structural components depending on the intended use environment. For example, lightweight aluminum construction may be preferred for portability, while stainless steel may be selected for high-volume industrial applications. High-strength composite materials such as reinforced polymers or carbon-fiber laminates may be used for weight reduction while maintaining stiffness. Surfaces that contact heated vinyl may be coated with temperature-resistant materials to prevent adhesion or degradation. The choice of materials may be determined based on factors such as cost, expected wear, and operating temperature range.

Manufacturing of the device 100 may employ conventional fabrication techniques such as machining, extrusion, casting, and welding. Tolerances for moving components such as the sliding rail 109, hinges 115 and 117, and folding members 105 may be maintained within acceptable ranges to ensure smooth operation without excessive play. Fasteners may be secured using thread-locking compounds or locking nuts to prevent loosening due to vibration. Edges of the receiver 101 and second member 107 may be chamfered or rounded to minimize the risk of damaging the floor plank 103 during insertion or removal. The device 100 may be assembled using modular subassemblies that simplify maintenance and allow component replacement.

In some embodiments, the device 100 may be configured with multiple receivers 101 arranged in series along a single frame. Each receiver 101 may include its own folding members 105, hinges 115, and handles 111, 113. This arrangement may allow the user to perform multiple bends along a single floor plank 103 without repositioning it between operations. Each receiver 101 may be independently adjustable using separate sliding rails 109 and locking mechanisms. Such a multi-station configuration may be suitable for manufacturing environments where efficiency and throughput are prioritized.

The device 100 may also be used with materials other than vinyl, including laminate flooring, engineered wood, or thermoplastic composites. The heating and bending parameters may be adjusted to accommodate the thermal and mechanical properties of these materials. The sliding rail 109 and receiver 101 may be recalibrated to correspond to the specific thickness and flexibility of each type of plank. This versatility may allow the same device 100 to serve multiple flooring product lines. In such cases, interchangeable molds such as the third member 119 may be specifically designed to match the required curvature or edge geometry for non-vinyl materials.

Maintenance of the device 100 may include regular cleaning of the receiver 101, folding members 105, and third member 119 to remove residue from heated vinyl or adhesives. The hinges 115 and 117 may be lubricated periodically with light machine oil or grease to ensure smooth rotation. Any replaceable contact pads on the folding members 105 may be inspected for wear and replaced as needed to maintain even pressure distribution. The sliding rail 109 may be cleaned of debris and checked for alignment to prevent binding during adjustment. Such maintenance practices may prolong the operational life and accuracy of the device 100.

In certain configurations, additional safety features may be incorporated into the device 100. These may include handle guards, heat shields, or mechanical stops that limit hinge rotation to a safe range. The device 100 may also include markings that indicate maximum allowable bending angles or material temperature limits. Electrical heating systems, if present, may include automatic shutoff or over-temperature protection. Such features may allow the device 100 to be used safely in both professional and residential settings. Safety elements may be integrated into the mechanical design without affecting functionality.

Each embodiment described herein may be used independently or in combination with one another to achieve the desired functionality. The described configurations of the receiver 101, folding members 105, hinges 115 and 117, sliding rail 109, handles 111 and 113, second member 107, third member 119, and table 200 may be interchanged or modified without departing from the structural relationships recited in the claims. Variations in component geometry, material composition, or actuation method may yield devices functionally equivalent to those depicted in FIG. 1 and FIG. 2. The examples provided are therefore intended to illustrate the scope of the mechanical and operational arrangements that may be realized through implementation of the described system.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A vinyl floor plank bending device, comprising:
a receiver forming a gap configured to partially receive a floor plank;

2. The vinyl floor plank bending device of claim 1, wherein the receiver comprises a first member and a second member that define the gap therebetween.

3. The vinyl floor plank bending device of claim 1, wherein the sliding rail is configured to adjust the gap width between approximately 4 millimeters and 10 millimeters.

4. The vinyl floor plank bending device of claim 1, wherein the folding member is configured to bend the floor plank at approximately 90 degrees.

5. The vinyl floor plank bending device of claim 1, wherein the folding member is configured to bend the floor plank into a U-shaped configuration.

6. The vinyl floor plank bending device of claim 1, further comprising an interchangeable mold removably attached to the receiver, the mold defining a bending profile for the floor plank.

7. The vinyl floor plank bending device of claim 6, wherein the interchangeable mold comprises a square mold and a round mold.

8. The vinyl floor plank bending device of claim 1, wherein the sliding rail comprises a locking mechanism configured to secure the receiver at a fixed position during bending.

9. The vinyl floor plank bending device of claim 1, wherein the handle is configured for single-hand operation.

10. The vinyl floor plank bending device of claim 1, wherein the receiver and the folding member are constructed of aluminum to provide a lightweight and portable structure.

11. The vinyl floor plank bending device of claim 1, wherein the receiver includes a clamping mechanism configured to retain the floor plank within the gap during bending.

12. The vinyl floor plank bending device of claim 1, wherein the folding member comprises multiple hinges configured to distribute bending pressure evenly along the width of the floor plank.

13. The vinyl floor plank bending device of claim 1, wherein the handle comprises an ergonomic grip configured to enhance user control and stability during operation.

14. The vinyl floor plank bending device of claim 1, wherein the receiver is mounted on a base configured to be secured to a workbench or table.

15. The vinyl floor plank bending device of claim 1, wherein the receiver includes measurement indicators positioned adjacent to the gap to assist with floor plank alignment.

16. The vinyl floor plank bending device of claim 1, wherein the folding member comprises a replaceable contact pad configured to prevent damage to a surface of the floor plank during bending.

17. The vinyl floor plank bending device of claim 1, wherein the receiver defines a gap depth of approximately one inch.

18. A vinyl floor plank bending device, comprising:
heating a portion of the floor plank to a pliable temperature;

19. The method of claim 18, further comprising positioning an interchangeable mold within the receiver to form either a square stair-nose profile or a round stair-nose profile.

20. A system for bending vinyl floor plans, comprising:
a receiver defining a gap configured to partially receive a vinyl floor plank;
a sliding rail coupled to the receiver and configured to selectively adjust a width of the gap according to a thickness of the vinyl floor plank;
a folding member pivotally connected to the receiver by at least one hinge;
a handle coupled to the folding member and configured to apply bending pressure; and
an interchangeable mold removably connected to the receiver and configured to define a desired bending profile of the vinyl floor plank.
